(19) United States
(12) Patent Application Publication
(10) Pub. No.: US 2025/0203063 A1
(43) Pub. Date: Jun. 19, 2025

(54) SYSTEM WITH INTEGRATION OF FLAT DISPLAY AND FLOATING IMAGE DISPLAY AND OPERATING METHOD

(71) Applicant: Lixel Inc., Hsinchu City (TW)

(72) Inventors: CHUN-HSIANG YANG, Hsinchu City (TW); CHUN-LIN LIN, Hsinchu City (TW); YUNG-CHENG CHENG, Taoyuan City (TW); CHIH-HUNG TING, New Taipei City (TW); CHIH-WEI SHIH, Hsinchu City (TW)

(21) Appl. No.: 18/984,341

(22) Filed: Dec. 17, 2024

Related U.S. Application Data
(60) Provisional application No. 63/611,450, filed on Dec. 18, 2023.

(51) Int. Cl. H04N 13/398; G02B 30/56; H04N 13/305; H04N 13/366

(52) U.S. Cl. CPC H04N 13/398; G02B 30/56; H04N 13/305; H04N 13/366

(57) ABSTRACT

A system with integration of a flat display and a floating-image display and an operating method are provided. The system includes a flat display module and a floating-image display module. In an initialization procedure, a signal channel is established between the flat display module and the floating-image module. The flat display module displays a 2D image according to a flat display signal. A floating-image display signal is generated according to a control instruction, and accordingly a floating-image display is used to display a floating image. After that, the floating-image display module receives an interaction instruction that is calculated when the floating-image display module receives a signal generated by manipulating the floating image. The floating-image display module updates the floating image according to the interaction instruction, and the flat display module correspondingly displays another 2D image.

### CROSS-REFERENCE TO RELATED PATENT APPLICATION

This application claims the benefit of priority to the U.S. Provisional Patent Application Ser. No. 63/611,450, filed on Dec. 18, 2023, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a technology of interaction between a 2D image and a three-dimensional image, and more particularly to a system that integrates a flat display and a floating-image display for providing a user to use a floating-image for interaction and an operating system of the system.

### BACKGROUND OF THE DISCLOSURE

It is common for a user to manipulate a mobile phone, a tablet computer, or a kiosk to interact with the contents displayed thereon. Such devices allow the user to manipulate a content displayed on a flat display of the device by their gesture, by which an operating system operated in the device determines an operational instruction by sensing the gesture and displaying a corresponding image to respond to the operational instruction, thereby achieving interactive operation through the devices.

When browsing a specific image object, for example, the flat display provides a 2D (two-dimensional) image for the user to browse. Furthermore, if the user wants to view the image object in 360-degree angle, the device is required to provide the image object with three-dimensional data. Therefore, the user can view the image object by a remote control or a gesture from various viewing angles. However, since the conventional technology only allows the user to rotate or zoom in/out the image object over the flat display, there is still room for improvement in terms of user experience.

### SUMMARY OF THE DISCLOSURE

In response to the above-referenced technical inadequacies, the present disclosure provides a system with integration of a flat display and a floating-image display, and an operating method thereof, so as to improve the user experience for interaction when browsing a three-dimensional image. The system allows users to interact with contents displayed on the flat display and the floating-image display. For example, the user can manipulate a floating image displayed on the floating-image display to control the content displayed on flat display through gesture operation.

In one aspect, the system essentially includes a flat display module and a floating-image display module. In an initialization procedure of the method for operating the system which is activated, a signal channel is established over a communication interface between the flat display module and the floating-image display module. After that, in response to a flat display signal, a 2D image is displayed by a display panel of the flat display module. A floating-image display signal is then generated according to a control instruction, and a floating-image display of the floating-image display module displays the floating image.

Next, a control circuit of the floating-image display module receives an interaction instruction that is computed when a user manipulates the floating image, and the control circuit updates the floating image in response to the interaction instruction. The flat display module then receives the interaction instruction via the signal channel, and the display panel correspondingly displays another 2D image.

The flat display module and the floating-image display module are integrated into one device or implemented by two signally-connected standalone devices.

Further, the floating-image display module connects with a floating-image database via a data-transmission circuit, and the floating-image database provides the floating-image data for the floating-image display module to display the floating image.

Further, the system also includes a gesture sensor that is connected with the floating-image display module, when the floating-image display displays the floating image, the gesture sensor is driven to sense a gesture performed by the user to manipulate the floating image.

Still further, when the interaction instruction is generated in response to the gesture, the floating-image display module retrieves a floating-image data from a floating-image database according to the control instruction, so as to update the floating image to be displayed.

Further, when the floating image is updated, a signal is transmitted to the flat display module via the signal channel for the flat display module to display another corresponding 2D image.

Still further, the above-mentioned control instruction can be an instruction that instructs the 2D image to be converted to the floating image and drives the floating-image display module to load a floating-image data corresponding to the 2D image. The floating-image display module then displays the floating image corresponding to the 2D image.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram illustrating a system with integration of a flat display and a floating-image display according to one embodiment of the present disclosure;

FIG. 2 is a schematic diagram depicting the floating-image display according to one embodiment of the present disclosure;

FIG. 3 is a schematic diagram illustrating circuit elements of the system with integration of a flat display and a floating-image display according to one embodiment of the present disclosure;

FIG. 4 is a flowchart illustrating a method for operating the system with integration of a flat display and a floating-image display in one embodiment of the present disclosure;

FIG. 5A to FIG. 5C are schematic diagrams illustrating interactions performed by the system with integration of a flat display and a floating-image display according to one embodiment of the present disclosure;

FIG. 6 is a schematic diagram illustrating interactions performed by the system with integration of a flat display and a floating-image display according to another embodiment of the present disclosure;

FIG. 7 is a schematic diagram illustrating a first implementation of the system with integration of a flat display and a floating-image display according to one embodiment of the present disclosure; and

FIG. 8 is a schematic diagram illustrating a second implementation of the system with integration of a flat display and a floating-image display according to another embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The present disclosure relates to a system with integration of a flat display and a floating-image display and an operating method thereof. The system includes the flat display used to display information of images and the floating-image display used to display a floating image. The system allows a user to browse and manipulate the floating image, and also to interact with the contents displayed on the flat display. The floating image is such as a three-dimensional image that is extended from the content displayed on the flat display, or a virtual manipulation interface that is provided for the user to manipulate and control the contents to be displayed on the flat display.

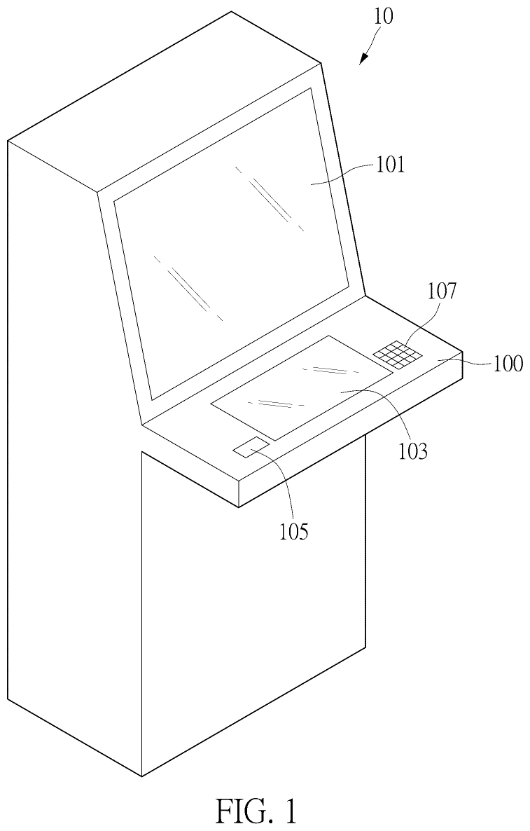

Reference is made to FIG. 1, which is a schematic diagram depicting an outward appearance of a device with integration of a flat display and a floating-image display according to one embodiment of the present disclosure. An interactive image display 10 that includes a flat display module 101 is provided. The flat display of the flat display module 101 is not limited to any display technology. For example, a display panel, a backlight module, and a control circuit are combined to form the flat display module 101. One of the functions of the flat display module 101 is to display information of various 2D images. The interactive image display 10 has a floating-image display module 103 that includes a floating-image display and control circuits. A display interface for projecting the floating image is disposed on a control desk 100 shown in the diagram. The interactive image display 10 integrates the flat display module 101 and the floating-image display module 103 through a mechanical design, circuit connections and collaboration of software and the circuits, so that the different display technologies can be collaboratively operated.

In one of the embodiments of the present disclosure, the flat display is disposed at an upper portion of the interactive image display 10, and the flat display is provided for displaying a 2D image for a user. The floating-image display is disposed on the control desk 100, and the floating-image display is provided for the user to perform gestures for interacting with the floating image. Further, the interactive image display 10 includes a gesture sensor 105 that can be disposed inside the floating-image display module 103 or signally connected with the floating-image display module 103. The gesture sensor 105 is used to assist in sensing the user's gesture. The interactive image display 10 also includes a control panel 107 provided for the user to control the device with integration of the flat display and the floating-image display. For example, the control panel 107 provides a manipulation interface having buttons, a joystick and a touch panel.

In an exemplary example, in one of operating modes of the interactive image display 10, the user can use the control panel 107 to control the device when viewing the content displayed by the flat display. The floating-image display disposed on the control desk 100 displays manipulation functions that are provided for the user to manipulate the device or displays a floating image for the user to view. The floating image is preferably a three-dimensional image that is projected as a real image above the display interface at a distance. The three-dimensional image allows the user to manipulate by his gesture. The gesture sensor 105 is then used to sense the gesture and the floating image is driven to be changed according to the gesture.

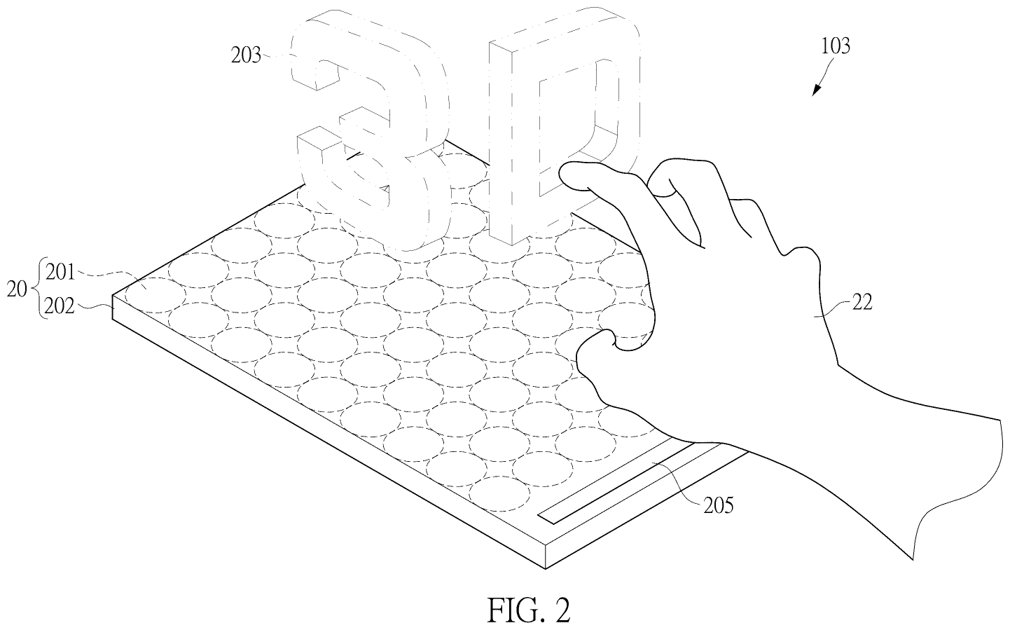

Reference is made to FIG. 2, which is a schematic diagram illustrating the display technology of the floating-image display according to one embodiment of the present disclosure.

The above-described floating-image display module 103 used to display a floating image by a floating-image display 20 is exemplarily shown in the diagram. The floating-image display 20 essentially consists of an optical module 201 and a display panel 202. The floating-image display 20 has an image processor (not shown in the diagram) that is used to process the displayed contents. The floating-image display 20 is capable of communication via a specific communication module (not shown in the diagram), and therefore able to receive floating-image data from external image sources. The floating-image data is then processed by the image processor for generating a floating image 203.

According to one embodiment of the present disclosure, the optical module 201 of the floating-image display 20 is a lens array being composed of multiple lens elements. The optical module 201 and the display panel 202 are combined in opposition. The display panel 202 is a flat display panel that is used to display an integrated image consisting of multiple unit images. Each of the unit images corresponds to one or more lens elements of the optical module 201. Further, the each of the unit images can be used to project the floating image 203 in a one-to-one, one-to-many or many-to-one manner. It is worth noting that the one-to-one manner indicates that each of the unit images corresponds to a lens element, the one-to-multiple manner indicates that each of the unit images corresponds to the multiple lens elements, and the multiple-to-one manner indicates that the multiple unit images correspond to a lens element. Accordingly, it is necessary to consider characteristics of the components of the floating-image display 20 and the floating image 203 to be finally displayed to generate the multiple unit images and the integrated image. As mentioned above, each of the unit images corresponds to each of the lens elements of the optical module 201. In one of the embodiments of the present disclosure, the lens elements can be composed of one or more convex and concave lenses. When the floating-image display 20 is in operation, the multiple unit images displayed on the display panel 202 are projected as the three-dimensional floating image 203 above the floating-mage display 20 through a lens array of the optical module 201. The floating image 203 is exemplarily shown as a word “3D” in the diagram.

Further, the floating-image display 20 includes a gesture sensor 205 that is used to sense the gesture performed upon the floating image 203 by a hand 22 of the user. The gesture sensor 205 can be implemented by an image detection method, in which a camera is used to capture a series of images of one or more key portions of the hand 22. The key portions are such as a finger, a palm, and/or knuckles. Through an image processing method, changes of the images of the hand 22 within a period of time can be obtained. Each of the key portions of the hand 22 can be depicted by three-dimensional coordinates Xₛₑₙₛₒᵣ, Yₛₑₙₛₒᵣ and Zₛₑₙₛₒᵣ in the Cartesian coordinate system or γ, θ and φ in the spherical coordinate system with respect to the gesture sensor. After continuously acquiring the coordinates of gesture, a stereo coordinate variation can be obtained. The coordinates of the sensor-based coordinate system can be transformed to a display-based coordinate system with respect to the floating-image display 20. Variations in three-dimensional coordinates (X_{device}, Y_{device}, Z_{device}) can be expressed by vectors (i.e. displacement and direction) and rates (i.e. distance and time). The variations are provided for the system to determine an interaction instruction including one or any combination of moving, rotating or zooming actions.

In one further embodiment, the gesture sensor 205 senses a gesture by the principle of light blocking. The gesture sensor 205 uses a light source to emit a sensing light and also a photo sensor to sense light spots on the hand 22 of the user when the hand 22 blocks the light in a range of the sensing light. Therefore, an amount of light spots reflected by each of the key portions and time differences among the light spots can be obtained. It should be noted that the light spots reflected by the key portions reflect changes of the key portions, and the time differences indicate the information relating to depths of the key portions. Similarly, the light information being obtained continuously can be used to obtain stereo coordinate variations formed by the gesture. The gesture allows the system to identify an interaction instruction indicative of one or any combination of the actions such as moving, rotating and zooming.

In one further embodiment, the gesture sensor 205 can be implemented by a sound generator and a sound receiver that uses acoustic waves reflected by the hand 22 to determine the gesture. When the hand 22 of the user is within a sensing range of the acoustic waves of the gesture sensor 205, the hand 22 blocks the acoustic waves, and the reflected waves are formed. When the sound receiver receives the reflected waves, the changes of the reflected waves allow the sound receiver to detect variations of the key portions of the hand 22 in a space. The variations of the key portions can be interpreted as the stereo coordinate variations that can be used to determine the interaction instruction indicative of one or any combination of the actions such as moving, rotating and zooming.

The gesture sensor 205 can be implemented by a variety of technologies in the interactive sensing method for sensing the gesture performed by the user. The gesture indicates the positions of the fingers, the palm and/or the knuckles of the hand 22 of the user, and especially the variations of three-dimensional coordinates of the knuckles so as to determine the interaction instruction indicative of one or any combination of actions such as moving, rotation and zooming. After that, by querying the floating image data in an image database, a new corresponding floating image data can be used to display a next floating image data. The floating image data may include a static three-dimensional image or a video formed by a series of three-dimensional images. It should be noted that an interactive effect that instantly reacts to the user's gesture can be achieved by using processes including sensing the variations, transforming the coordinates, and calculating the floating image when high-speed computation is performed.

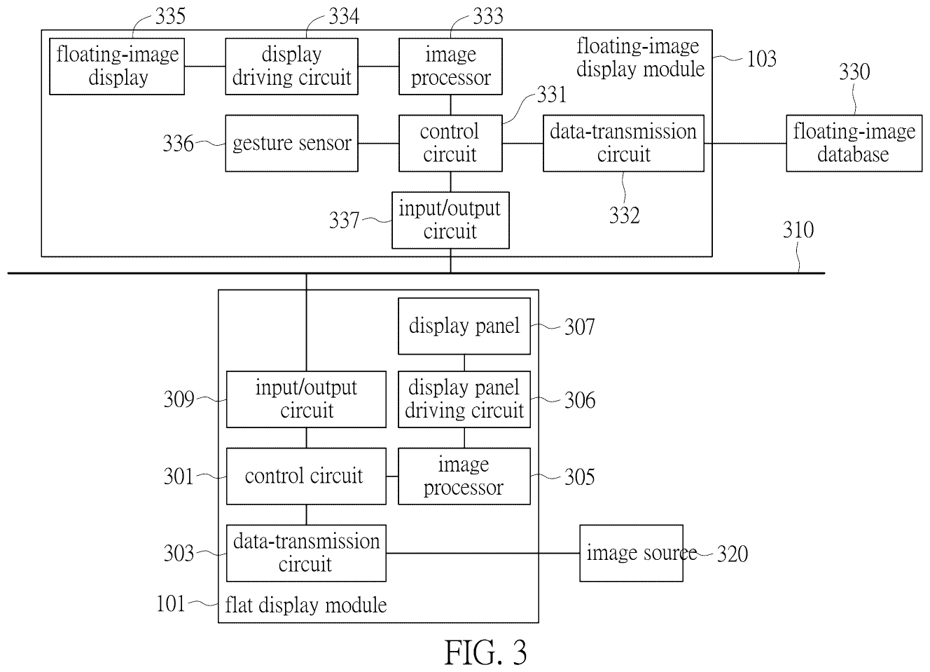

Reference is made to FIG. 3, which are schematic diagram depicting circuit components of the system with integration of a flat display and a floating-image display according to one embodiment of the present disclosure.

The system mainly includes a flat display module 101 and a floating-image display module 103 that are signally-connected with each other. In one embodiment of the present disclosure, the flat display module and the floating-image display module can be integrated into one device or are two standalone devices that are signally-connected.

The flat display module 101 essentially includes a control circuit 301 that is used to control operations of the flat display module 101. The control circuit 301 is electrically connected with other circuit components such as a data-transmission circuit 303. The flat display module 101 retrieves image data from an image source 320 via the data-transmission circuit 303. An image processor 305 performs image processing including decoding, decompressing, and converting the image data to a data in a specific format. The data is provided to a display panel driving circuit 306 for driving the display panel 307 to display a 2D image.

In the system with integration of a flat display and a floating-image display of the present disclosure, the flat display module 101 and the floating-image display module 103 are communicated via a communication interface 310, e.g., a communication bus, and can be used to transmit signals there-between. Interaction between the flat display module 101 and the floating-image display module 103 is therefore achieved. In an exemplary example, an input/output circuit 309 of the flat display module 101 connects the communication interface 310, and the input/output circuit 309 is used to transmit signals in a specific format. The signals are transmitted to the floating-image display module 103 via the communication interface 310, and correspondingly the flat display module 101 receives signals generated by the floating-image display module 103 via the communication interface 310.

In the floating-image display module 103, a control circuit 331 is configured to control the floating-image display module 103 to operate. The control circuit 331 is signally connected with circuit elements in the floating-image display module 103 and the circuit elements are such as a data-transmission circuit 332. The floating-image display module 103 connects with a floating-image database 330 via the data-transmission circuit 332. The floating-image database 330 provides the floating-image data used to render a floating image to be displayed on the floating-image display module 103. The floating-image data includes color information and three-dimensional spatial information of the various three-dimensional images. The floating-image database 330 can provide the floating-image data based on the requirement of the floating image to be displayed by the floating-image display module 103 at any time.

When the floating-image data is processed by an image processor 333 of the floating-image display module 103, the image data for rendering the floating image is generated. The image data is provided for a display driving circuit 334 to convert the image data into display signals that are provided for a floating-image display 335 to display the floating image. Finally, the floating-image display 335 displays the floating image according to the display signals. Then, the floating-image display module 103 projects the floating image over the display panel. In the meantime, a gesture sensor 336 is driven to be operated for sensing a gesture performed on the floating image by a user and generating a corresponding interaction instruction. More floating-image data can be then retrieved from the floating-image database 330 according to the interaction instruction so as to update the currently-displayed floating image. Alternatively, the floating-image data can be converted into the signals in a specific format via an input/output circuit 337. A signal channel being established over the communication interface 310 is used to transmit signals to the flat display module 101, and the flat display module 101 can be used to display one further 2D image.

According to one embodiment of the present disclosure, when a gesture is sensed by the gesture sensor 336, a change of three-dimensional coordinates with respect to the floating image can be determined according to the gesture performed on the floating image by the user. Therefore, the control circuit 331 relies on the change of the three-dimensional coordinates to determine the interaction instruction such as a rotating instruction, a zooming instruction or a zooming instruction. Image coordinates of a new floating image are then calculated according to the interaction instruction so as to obtain an updated floating-image data, or apply the obtained floating-image data to update the currently-displayed floating image.

It should be noted that the change of three-dimensional coordinates corresponding to the gesture sensed by the gesture sensor 336 is indicative of the coordinates referring to the gesture sensor 336 that acts as a reference coordinate system. The change of three-dimensional coordinates is then provided for the control circuit 331 to perform coordinate transformation, so that, in response to the interaction instruction, the coordinates in the coordinate system with the gesture sensor 336 are transformed to the coordinate system referring to the space having the floating image.

The positions of all parts of the floating image displayed by the floating-image display module 103 are known, and therefore a correlation that the gesture is transformed to the same coordinate system with the floating image can be identified. The above-mentioned correlation indicates a relationship between the three-dimensional coordinates formed by the gesture and the floating image displayed by the floating-image display module 103. For example, a moving gesture drives the floating image to move toward a specific direction, and therefore the change of this specific direction should be added to the three-dimensional coordinates of the floating image. Therefore, a new floating image can be obtained at a new position. The control circuit 331 can also render a new floating-image data by querying the floating-image database 330 in real time, or calculate a new floating-image data in real time. The floating-image data is provided for the display driving circuit 334 to generate an image.

For example, when the user performs a rotating gesture, the floating image is driven to rotate in a specific direction based on the three-dimensional coordinates of the floating image that add a change of rotation. Accordingly, a new floating-image data used to display a new floating image can be obtained. Similarly, when the user performs a zooming gesture on the floating image, the size of the floating image is changed at a same reference position and the three-dimensional coordinates of the floating image are also changed. A new floating-image data can also be generated when the control circuit 331 queries the floating-image database 330 or performs computation in real time. The new floating-image data is then provided to the display driving circuit 334 for generating display signals.

The above-mentioned moving gesture, rotating gesture and zooming gesture can be combined in any way so as to generate the interaction instruction. The interaction instruction is provided for the image processor 333 to calculate the new floating-image data. The new floating-image data is provided for the floating-image display 20 to directly display the floating image.

According to one further embodiment of the system with integration of a flat display and a floating-image display, the floating-image display module 103 connects with a control system, i.e., the system with integration of the flat display and the floating-image display via a communication interface that can be implemented by a wireless connection (e.g., WiFi™ or Bluetooth™) or a wired connection (e.g., USB, RS232 or any industrial standard interface). A control interface can be implemented by the control panel 107 exemplarily shown FIG. 1. The control system operates a computer system and executes a driver for intercommunicating the flat display module 101 and the floating-image display module 103. Accordingly, the floating-image display module 103 can transmit an interaction instruction that is generated by a gesture, a voice or any input method to the flat display module 101. The flat display module 101 can display a 2D image in response to the interaction instruction. Further, the image signals of the image displayed by the flat display module 101 can be transmitted to the floating-image display module 103 via the communication interface 310. Further, the floating-image display module 103 can accordingly display the floating image.

According to one embodiment of the present disclosure, the communication interface 310 between the flat display module 101 and the floating-image display module 103 can be used to translate and compile the messages to be transmitted there-between. The control circuit 301 of the flat display module 101 and the control circuit 331 of the floating-image display module 103 can respond to each other's messages and respectively display the corresponding 2D image and floating image.

In the above-described embodiment, the system with integration of a flat display and a floating-image display achieves content conversion between the 2D image and floating image. For example, when a user looks at the content displayed on the flat display, the floating-image display module 103 is driven to display a corresponding floating image under a specific condition or when the user triggers a function of the floating-image display module 103. The floating image can reveal a three-dimensional image with respect to a display content being displayed on the flat display. The user can manipulates the floating image by gestures. The three-dimensional image allows the user to easily view multiple viewing angles of an object shown as a 2D image. The gesture sensor is used to sense the gestures performed by the user. In addition to converting the floating image to the next floating image corresponding to a gesture, the system drives the flat display module 101 to display an image that reflects the gesture on the flat display. In should be noted that the way of manipulating the floating images is not limited to the above-described gestures, but can also include voice or other input methods.

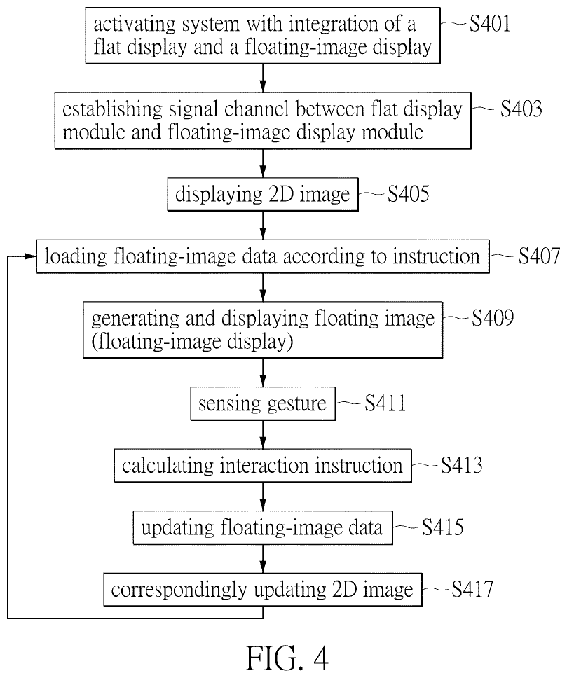

Reference is made to FIG. 4, which is a flowchart illustrating the method for operating the system with integration of a flat display and a floating-image display according to one embodiment of the present disclosure.

In the flowchart, the system with integration of a flat display and a floating-image display is firstly activated (step S401), and an initialization procedure is executed. A signal channel between the flat display module and the floating-image display module is established over the communication interface (step S403).

In the flat display module, the user manipulates the control panel so as to generate flat display signals, or the control circuit of the flat display module can generate the flat display signals by default. After the flat display signals are processed by the image processor, a display panel is driven to display a 2D image (step S405). In the floating-image display module, the user manipulates the control panel to generate control instructions, or the control circuit of the floating-image display module generates the control instruction by default. The control circuit of the float-image display module relies on the control instruction to generate the floating-image display signals for rendering the floating image. It should be noted that the floating-image data is loaded from the floating-image database (step S407). After the image processor processes the floating-image data, the floating image is displayed by the floating-image display (step S409).

In a first operating mode of the system with integration of a flat display and a floating-image display according to one embodiment of the present disclosure, the control instruction can be an instruction for converting the 2D image into the floating image, and the control instruction makes the floating-image display module load a corresponding floating-image data relating to an object in the 2D image from the floating-image database. The floating-image data records color information and three-dimensional spatial information used to describe the object. The floating-image display module can display the floating image corresponding to the 2D image based on the floating-image data.

Next, the user can perform gesture so as to manipulate the floating image, and the gesture sensor can sense the gesture (step S411). The control circuit of the floating-image display module receives an interaction instruction that is calculated in response to the gesture performed on the floating image by the user (step S413). Thus, the floating-image display module updates the floating-image data according to the interaction instruction (step S415). Then the flow can return to step S407, in which the floating-image display module continuously loads the new floating-image data from the floating-image database according to the instruction for updating the floating image. The new floating-image data is then calculated to be the updated floating image.

On the other hand, the flat display module receives the interaction instruction via the signal channel and then updates the 2D image to be a new float image displayed on the display panel correspondingly (step S417). Accordingly, the purpose of interaction made in between the 2D image and the floating image is achieved.

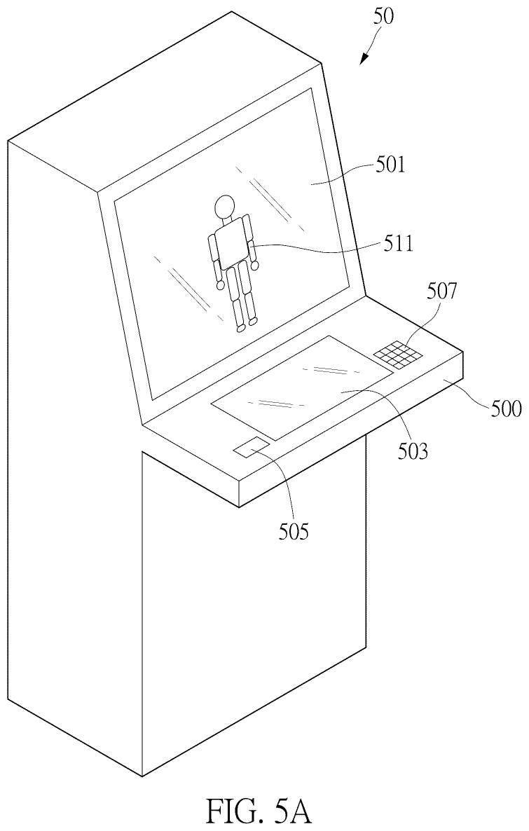

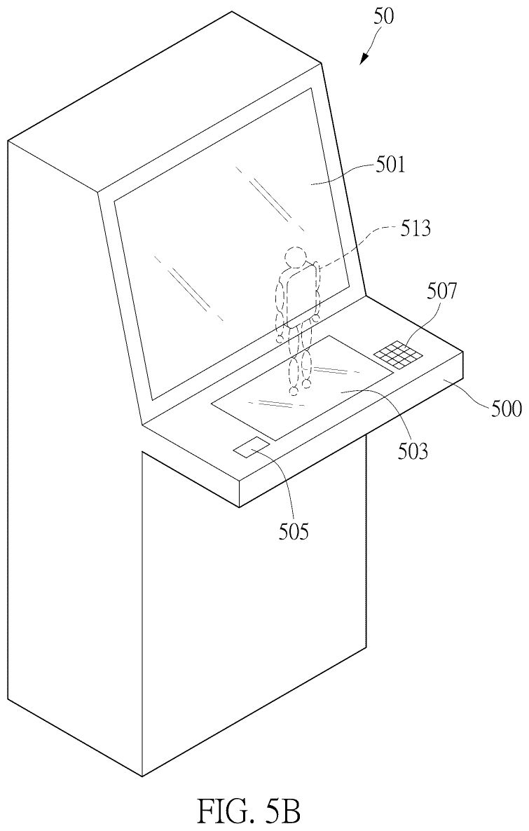

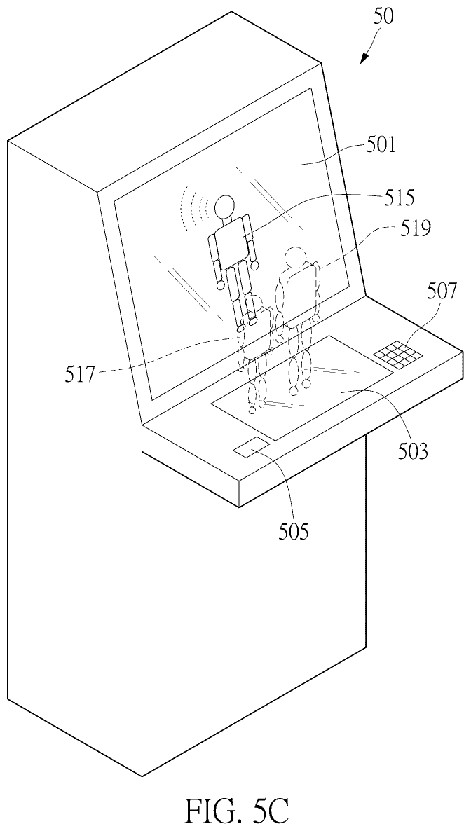

In a second operating mode of the system with integration of a flat display and a floating-image display, references are made to FIG. 5A to FIG. 5C, which are schematic diagrams illustrating interactions made by the system according to another embodiment of the present disclosure.

In FIG. 5A, an interactive image display 50 shown in the diagram integrates a flat display module 501, a floating-image display module 503 and a gesture sensor 505. A control panel 507 is disposed on a control desk 500. This exemplary example shows that the display panel of the flat display module 501 displays a 2D image 511, e.g., a person.

In FIG. 5B, a user manipulates the interactive image display 50 through the control panel 507 and asks for showing a three-dimensional image of the person. In the meantime, the floating-image display module 503 loads the floating-image data of the person from the floating-image database, and then displays the person with a floating image 513 by the floating-image display.

Next, the user performs gestures on the floating image 513, the gesture sensor 505 continuously senses the gestures, and the floating-image display module 503 calculates the corresponding interaction instructions. As FIG. 5C shows, the flat display displays another corresponding 2D image 515. During the interactions, the floating-image display module 503 continuously calculates new floating images used to update the floating image, e.g., the floating images 517 and 519.

In an example under the above-described second operating mode, the system with integration of a flat display and a floating-image display initially displays a virtual character through the flat display; for example, the virtual character is used to present contents with voices and animations that may be used to tell stories or introduce products. When the user asks for using a floating image to present the contents, the system drives the floating-image display to display the floating image through three-dimensional calculations. Therefore, the contents can be presented through voices and an animated three-dimensional image. In the meantime, the user can perform gestures, voice commands, or other input methods to interact with the floating image. Correspondingly, the system can use the flat display to display another flat character image to respond to the interaction instruction that is generated when the user manipulates the floating image. Thus, the user can more intuitively watch and interact with the virtual character in a fun and interactive scenario; for example, the system can be used in teaching for enhancing learning experiences for students.

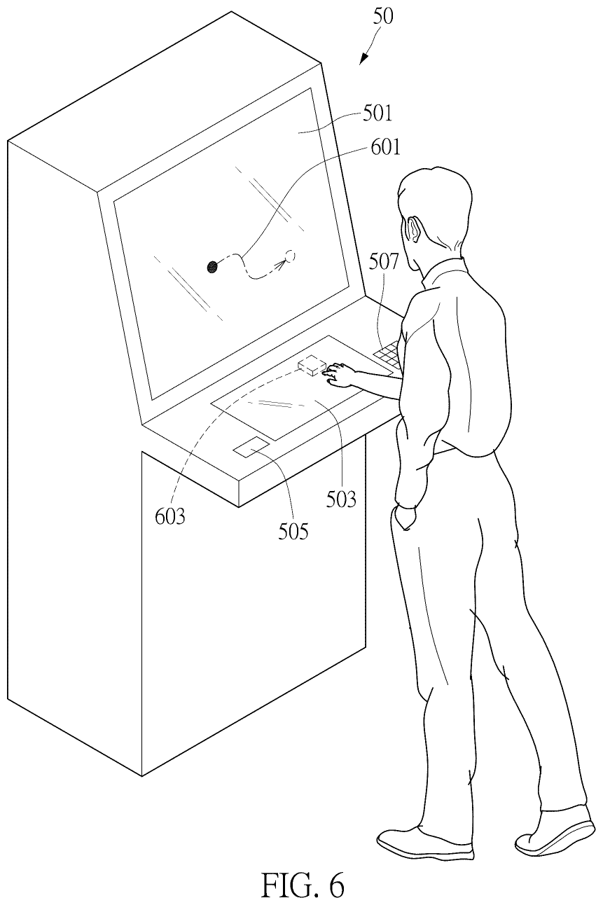

Reference is next made to FIG. 6, which is a schematic diagram illustrating a third operating mode of the system with integration of a flat display and a floating-image display according to one embodiment of the present disclosure.

The interactive image display 50 shown in the diagram can load a floating-image data from the floating-image database via a virtual floating control interface 603 according to a control instruction from the user's manipulation. For example, the virtual floating control interface 603 can be a virtual button, a virtual touch pad or a virtual joystick that allows the user to manipulate the content displayed on the flat display through the floating image. The present example shows that the flat display displays a trajectory 601 being generated by the user's manipulation.

For example, the system with integration of a flat display and a floating-image display can implement a game console that achieves various control interfaces through the floating-image display module. The floating-image display module allows the user to perform gestures on a floating control interface for playing a game. The trajectory 601 shown in the diagram can be a route that a character travels in the game. Further, the system also implements the game console that integrates a two-dimensional image and a three-dimensional floating image. Through collaboration of software and hardware, the user plays the game with the two-dimensional image and performs gestures on the three-dimensional floating image; for example, the user plays the game with two-dimensional images and the game console presents specific information with the floating image.

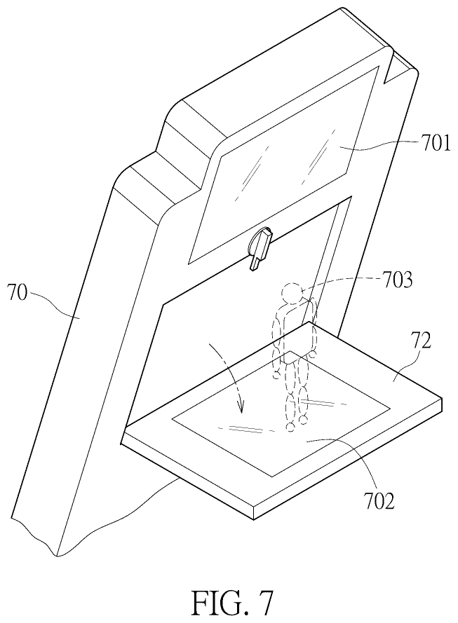

Reference is next made to FIG. 7, which is a schematic diagram illustrating one of applications of the system with integration of a flat display and a floating-image display according to one embodiment of the present disclosure.

The diagram shows that the system with integration of a flat display 701 and a floating-image display 702 is installed in a seat 70 of an aircraft or a vehicle. The flat display 701 is embedded into a chair back of the seat 70, and the floating-image display 702 is mounted onto a foldable storage tray 72.

In a use circumstance, the flat display 701 initially displays a 2D image. When the user manipulates the tray 72 from a folded storage state to a use state, a control switch in a pivot mechanism is triggered for activating a floating-image display module for displaying a floating image 703 (e.g., a virtual character shown in the diagram) that allows the user to interact with the virtual character.

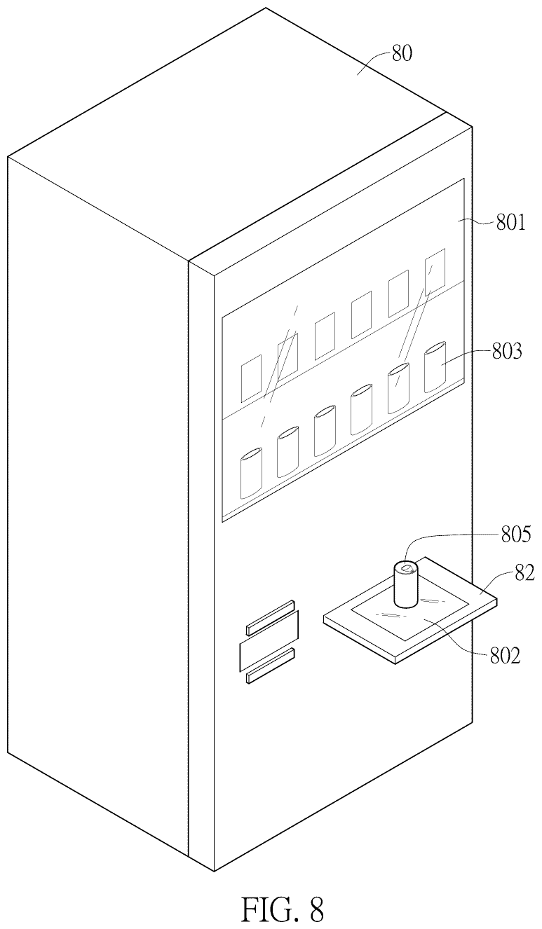

FIG. 8 is a schematic diagram illustrating the system with integration of a flat display 801 and a floating-image display 802 applied to a vending machine 80 according to one embodiment of the present disclosure. The vending machine 80 displays information of merchandises 803 for sale and the prices through the flat display 801. The vending machine 80 provides a display desk 82 for installing the floating-image display 802.

In one application, a user can select one of the merchandises to be purchased through the flat display 801 or other interfaces, and a control circuit of the vending machine 80 drives the floating-image display 802 to display a floating image 805 showing the merchandise selected by the user. The user can then manipulate the floating image 805 to browse a three-dimensional image of the merchandise.

According to the above embodiments of the system with integration of a flat display and a floating-image display, the system achieves the purpose of interaction between a 2D image and a three-dimensional image, and effectively improves the user experiences on merchandise browsing, audiovisual interaction, teaching and gaming.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A system with integration of a flat display and a floating-image display, comprising:
a flat display module; and
a floating-image display module, connecting to the flat display module via a communication interface;
wherein a method for operating the system with integration of the flat display and the floating-image display comprises:
in an initialization procedure when the system is activated,
establishing a signal channel over the communication interface between the flat display module and the floating-image display module;
in response to a flat display signal, using a display panel of the flat display module to display a 2D image;
generating a floating-image display signal according to a control instruction for displaying a floating image by the floating-image display of the floating-image display module;
receiving an interaction instruction that is computed by a control circuit of the floating-image display module when a user manipulates the floating image;
updating, by the control circuit of the floating-image display module, the floating image to be displayed according to the interaction instruction; and
receiving, by the flat display module, the interaction instruction via the signal channel, and correspondingly displaying another 2D image by the display panel.

2. The system according to claim 1, wherein the floating-image display module comprises a floating-image display having an optical module and a display panel, in which the optical module is a lens array having multiple lens elements, and the optical module and the display panel are combined in opposition; the display panel is used to display an integrated image that having multiple unit images, wherein each of the unit images corresponds to one or more lens elements of the optical module; and the multiple unit images to be displayed on the display panel are used to project a three-dimensional floating image above the floating-image display through the lens array.

3. The system according to claim 1, wherein the flat display module and the floating-image display module are integrated into one device or two signally-connected standalone devices.

4. The system according to claim 1, wherein the floating-image display module connects with a floating-image database via a data-transmission circuit, and the floating-image database provides floating-image data for the floating-image display module to display the floating image.

5. The system according to claim 1, further comprising a gesture sensor that is connected with the floating-image display module; when the floating-image display displays the floating image, the gesture sensor is also driven to sense a gesture performed by the user on the floating image.

6. The system according to claim 5, wherein, when the interaction instruction is generated in response to the gesture, the floating-image display module retrieves a floating-image data from a floating-image database according to the control instruction so as to update the floating image to be displayed.

7. The system according to claim 6, wherein, when the floating image to be displayed is updated, a signal is transmitted to the flat display module via the signal channel for displaying a corresponding 2D image.

8. The system according to claim 7, wherein the floating-image display module comprises a floating-image display having an optical module and a display panel; wherein the optical module is a lens array composed of multiple lens elements, and the optical module is combined with the display panel in opposition, in which the display panel is used to display an integrated image that is composed of multiple unit images and each of the unit images corresponds to one or more lens elements of the optical module; and wherein the display panel displays multiple unit images that are used to project a three-dimensional floating image above the floating-image display through the lens array.

9. A method for operating a system with integration of a flat display and a floating-image display, comprising:
activating and initializing the system with integration of the flat display and the floating-image display, and, in an initialization procedure, establishing a signal channel between a flat display module and a floating-image display module;
in response to a flat display signal, using a display panel of the flat display module to display a 2D image;
generating a floating-image display signal according to a control instruction for displaying a floating image by the floating-image display of the floating-image display module;
receiving an interaction instruction that is computed by a control circuit of the floating-image display module when a user manipulates the floating image;
updating, by the control circuit of the floating-image display module, the floating image to be displayed according to the interaction instruction; and
receiving, by the flat display module, the interaction instruction via the signal channel, and correspondingly displaying another 2D image by the display panel.

10. The method according to claim 9, wherein the user manipulates the floating image by gesture, and the interaction instruction is computed when the gesture is sensed by a gesture sensor.

11. The method according to claim 10, wherein, when the gesture is referred to for generating the interaction instruction, the floating-image display module updates and displays the floating image according to the control instruction, and, when the floating image is updated, a signal is transmitted to the flat display module via the signal channel for displaying a corresponding 2D image.

12. The method according to claim 9, wherein, in the floating-image display module, the control circuit loads a floating-image data from a floating-image database, and the floating image is generated when an image processor processes the floating-image data.

13. The method according to claim 12, wherein the control instruction instructs that the 2D image is converted to the floating image, and the control instruction also instructs the floating-image display module to load the floating-image data of an object corresponding to the 2D image and to display the floating image corresponding to the 2D image.

14. The method according to claim 13, wherein the floating-image data includes color information and three-dimensional spatial information of the object.

15. The method according to claim 12, wherein the control instruction instructs the floating-image display module to load the floating image data of a floating control interface, and the floating-image display module is used to display the floating control interface that is provided for the user to manipulate the floating control interface to control contents to be displayed by the flat display module.

16. The method according to claim 15, wherein the user manipulates the floating image by gesture, and the interaction instruction is computed when the gesture is sensed by a gesture sensor.

17. The method according to claim 16, wherein, when the interaction instruction is generated in response to the gesture, the floating-image display module updates the floating image to be displayed according to the control instruction; when the updated floating image is displayed, a signal is transmitted to the flat display module via the signal channel, and the flat display module is driven to display a corresponding 2D image.
